(19) United States
(12) Patent Application Publication
(10) Pub. No.: US 2025/0290250 A1
(43) Pub. Date: Sep. 18, 2025

(54) DRIED MODIFIED PULP WITH A CERTAIN CONTENT OF MICROFIBRILS AND PRE-FIBRILLATED FIBERS

(71) Applicant: Stora Enso OYJ, Helsinki (FI)

(72) Inventors: Ulla Jansson, Karlstad (SE); Anna-Maija Perander, Vällingby (SE); Laura Nousiainen, Enskede (SE); Mikko Suhonen, Joutseno (FI)

(73) Assignee: Stora Enso OYJ, Helsinki (FI)

(21) Appl. No.: 18/860,878

(22) PCT Filed: Apr. 27, 2023
(86) PCT No.: PCT/IB2023/054351

§ 371 Date: Oct. 28, 2024

(30) Foreign Application Priority Data
Apr. 29, 2022 (SE) 2230126-1

(51) Int. Cl. D21C 9/00

(52) U.S. Cl. CPC D21C 9/001

(57) ABSTRACT

The present invention relates to a modified pulp with a moisture content of less than 15% and a certain content of microfibrils and pre-fibrillated fibres. The modified pulp can, after suspension, be used either directly or be subjected to additional refining. The present invention also relates to a method of producing a fibrous product using the modified pulp.

### TECHNICAL FIELD

The present invention relates to a modified pulp with a certain content of microfibrils and pre-fibrillated fibres. The modified pulp can be used either directly or be subjected to additional refining. The present invention also relates to a method of producing a fibrous product using the modified pulp.

### BACKGROUND

Paper, paperboard and films comprising microfibrillated cellulose (MFC) or highly refined cellulose are known in the art. Depending on how they are produced, the paper, paperboard and films may have particularly advantageous strength and/or barrier properties, whilst being biodegradable and renewable. Films comprising MFC are for example used in the manufacture of packaging materials and may be laminated or otherwise provided on the surface of paper or paperboard materials.

There is still a need for more efficient methods for producing MFC efficiently and with limited use of energy both in respect of dewatering/drying and fibrillation/mixing, but also when considering the efficient mixing of functional chemicals into the gelled product. In addition, there is a need to be able to efficiently provide intermediate products that can readily be stored, transported and, if necessary, converted into microfibrillated cellulose on-site and shortly before use in a process for manufacturing a paper or board product. For such intermediate products, it is essential that the intermediate products can be used with limited energy input and ideally without the use of complex fiber activation, wetting agents, enzymatic treatments or expensive equipment.

When dewatering and drying micro fibrillated cellulose or pre-fibrillated fibres, such as in preparation for storage and/or transportation, there is a risk that the blending of materials fails or that co-drying causes hornification and subsequent loss of the effect provided by the fibrils. If that happens, the desired effects on for example strength and/or barrier properties of the final products will not be achieved.

A potential solution to overcome this problem is to reduce drying intensity or to use additives such as low molecular carbohydrates that reduces hornification. Such chemicals, however, can increase risks for microbial growth and is not a preferred solution.

EP3289004 relates to a process of producing a dry mixed product comprising cellulose filament and a carrier fibre, and a dry mixed product of re-dispersible cellulose filament and a carrier fibre that permits the cellulose filaments to retain its dispersibility in water and reinforcement ability in papermaking furnishes, composite materials, or other materials where cellulose filaments is used.

### SUMMARY

It is an object of the present invention to provide a method to overcome one or more of the prior art problems.

A specific object of the present invention is to provide an improved pulp that can easily be transported in dry form and that can be re-suspended to obtain a suspension comprising microfibrillated cellulose or highly refined pulp, wherein the beneficial strength or barrier properties of the microfibrillated cellulose or highly refined pulp has not been lost due to hornification of the microfibrillated cellulose or highly refined pulp resulting from drying. In particular, it has been found that the improved pulp according to the present invention provides improved tensile strength and stiffness properties in combination with gas barrier properties without significantly decreased bulk, in paper, paperboard and film products produced using the improved pulp. Surprisingly, it has also been found that products produced using the improved pulp according to the present invention has improved stretch properties, i.e. the products have an improved ability to stretch before they break.

In addition, an object of the present invention is to provide a method for producing such a pulp as well as the use thereof in the production of fibrous products such as paper, paperboard, moulded products and films.

The invention is defined by the appended independent claims. Embodiments are set forth in the appended dependent claims and in the following description.

According to a first aspect, there is provided a method for the production of a modified pulp, wherein the method comprises the steps of:
providing a wood pulp furnish;
mixing the wood pulp furnish with highly refined pulp and/or microfibrillated cellulose to obtain a fibrous suspension, wherein the total content of the highly refined pulp and/or microfibrillated cellulose in the fibrous suspension obtained is in the range of from 2 to 15 weight-%, based on total dry solid content, wherein the fibrous suspension has a dewatering resistance measured as Schopper-Riegler (SR) number in the range of 14-20, as determined by standard ISO 5267-1;
drying the fibrous suspension to obtain modified pulp having a moisture content of less than 15 wt-%.

A second aspect of the invention is the modified pulp obtained according to the first aspect. The modified pulp has a moisture content of less than 15%. The modified pulp comprises in the range of from 10 to 20% lamella-like fines, wherein the lamella-like fines are particles having width less than 10 μm and length over 0.2 mm. The percentage is a percentage of length, wherein the sum length of the lamella-like fines is divided by the sum length of all measured particles longer than 0.2 mm and multiplied by 100.

A third aspect of the invention is a method for preparing a fibrous product comprising the steps of
preparing a fibrous suspension of the modified pulp of the present invention;
forming an intermediate product comprising the fibrous suspension;
dewatering and drying the intermediate product to a moisture content of less than 15 wt-% to obtain the fibrous product.

A fourth aspect of the invention is a fibrous product prepared using the modified pulp according to the present invention.

### DETAILED DESCRIPTION

The wood pulp furnish used according to the present invention is prepared from dried or never dried fibers from softwood and/or hardwood. The wood pulp furnish is prepared using methods known in the art. Preferably, the wood pulp has a lignin content below 15% by weight, based on the total dry weight of the pulp, more preferably below 10% by weight, based on the total dry weight of the pulp. Preferably, the wood pulp has a hemicellulose content in the range of 10-30% by weight, based on the total dry weight of the pulp. The term wood pulp as used herein does not refer to regenerated or manufactured fibers, such as lyocell or viscose fibers. In one embodiment, the wood pulp is bleached. In one embodiment, the wood pulp is unbleached.

Highly refined pulp can be made from unfractionated cellulosic starting material. The highly refined pulp may also be prepared according to methods disclosed in WO2021/001751A. In this embodiment, the highly refined pulp is preferably produced by
a) providing a fine fiber fraction obtained by fractionation of a cellulose pulp;
b) subjecting said fine fiber fraction to refining at a consistency in the range of 0.5-30% by weight to a Schopper-Riegler (SR) number in the range of 80-98, as determined by standard ISO 5267-1, to obtain the highly refined pulp.

Thus, one embodiment of the present invention is a method for the production of a modified pulp, wherein the method comprises the steps of:
a) providing a wood pulp furnish;
b) providing a highly refined pulp, wherein the highly refined pulp is produced by
   i. providing a fine fiber fraction obtained by fractionation of a cellulose pulp;
   ii. subjecting said fine fiber fraction to refining at a consistency in the range of 0.5-30% by weight to a Schopper-Riegler (SR) number in the range of 80-98, as determined by standard ISO 5267-1, to obtain the highly refined pulp;
c) mixing the wood pulp furnish with the highly refined pulp to obtain a fibrous suspension, wherein the total content of the highly refined pulp in the fibrous suspension obtained is in the range of from 2 to 15 weight-%, based on total dry solid content, wherein the fibrous suspension has a dewatering resistance measured as Schopper-Riegler (SR) number in the range of 14-20, as determined by standard ISO 5267-1;
d) drying the fibrous suspension to obtain modified pulp having a moisture content of less than 15 wt-%.

The fine fiber fraction used in preparation of the highly refined pulp may for example be obtained by separating the cellulose pulp starting material in pressure screens to achieve a fraction with shorter and thinner fibers. The dry weight of the fine fiber fraction may for example comprise less than 75% by weight, less than 50% by weight, less than 25% by weight of the total dry weight of the unfractionated cellulose pulp starting material used in the preparation of the highly refined pulp.

If a fine fiber fraction is used in preparation of the highly refined pulp, it typically has a mean fiber length of fibers having a length >0.2 mm and below 1.7 mm (as determined according to ISO 16065-2) and a content of fibers having a length >0.2 mm of at least 5 million fibers per gram based on dry weight. The content of fibers having a length >0.2 mm of the fine fiber fraction is typically less than 10 million fibers per gram based on dry weight.

In the production of the highly refined pulp, the fine fiber fraction is obtained by size fractionation of a cellulose pulp starting material into a fine fiber fraction and a coarse fiber fraction. Compared to the cellulose pulp starting material, the fine fiber fraction has a higher amount of shorter and thinner fibers. The fine fiber fraction may for example be obtained by separating the cellulose pulp starting material in pressure screens to achieve a fraction with shorter and thinner fibers. The dry weight of the fine fiber fraction may for example comprise less than 75% by weight, less than 50% by weight, less than 25% by weight of the total dry weight of the unfractionated cellulose pulp starting material.

The refining of the fine fiber fraction to obtain the highly refined pulp is preferably carried out by refining with a total refining energy in the range of 100-1500 kW/t, preferably in the range of 500-1500 kW/t, more preferably in the range of 750-1250 KW/t.

The highly refined pulp preferably has a Schopper-Riegler (SR) number in the range of 80-98, more preferably in the range of 85-98, most preferably in the range of 90-98, as determined by standard ISO 5267-1. The highly refined pulp preferably has a content of fibers having a length >0.2 mm of at least 12 million fibers per gram based on dry weight. More preferably, the highly refined pulp has a content of fibers having a length >0.2 mm of at least 15 million fibers per gram based on dry weight, and preferably at least 20 million fibers per gram based on dry weight. Preferably, the highly refined pulp has a crill value of at least 1.7, preferably at least 1.8, more preferably at least 1.9. The content of fibers having a length >0.2 mm, as well as the crill value is determined using a L&W Fiber tester Plus instrument (L&W/ABB). The crill measurement method is based on utilizing the ability of particles to absorb and diverge light of different wavelengths depending on their diameter. By leading the a pulp suspension through one UV and one IR light source with a detector on the opposite side it is possible to detect if small particles is present in the solution. The more particles, the more light is diverged or absorbed. Small particles such as crill will spread and absorb the light from the UV light source whereas fibers will affect the light from the infrared light source. The crill content is obtained as a ratio of UV/IR detected.

Thus, one embodiment of the present invention is a method for the production of a modified pulp, wherein the method comprises the steps of:
a) providing a wood pulp furnish;
b) providing a highly refined pulp that has a content of fibers having a length >0.2 mm of at least 12 million fibers per gram based on dry weight;
c) mixing the wood pulp furnish with the highly refined pulp to obtain a fibrous suspension, wherein the total content of the highly refined pulp in the fibrous suspension obtained is in the range of from 2 to 15 weight-%, based on total dry solid content, wherein the fibrous suspension has a dewatering resistance measured as Schopper-Riegler (SR) number in the range of 14-20, as determined by standard ISO 5267-1;
d) drying the fibrous suspension to obtain modified pulp having a moisture content of less than 15 wt-%.

The microfibrillated cellulose used according to the present invention is preferably native microfibrillated cellulose. By native microfibrillated cellulose is meant that the microfibrillated cellulose is provided in its native form, i.e. without subjecting the fiber from which the microfibrillated cellulose originates or the microfibrillated cellulose as such to chemical derivatization in which functional groups bind covalently, such as for example phosphorylation or carboxymethylation.

The total amount of microfibrillated cellulose and/or highly refined pulp of the fibrous suspension is in the range of from 2 to 15 weight-% based on total dry solid content. Preferably, the total amount of microfibrillated cellulose and/or highly refined pulp of the fibrous suspension is in the range of from 3 to 13 weight-% based on total dry solid content. More preferably, total amount of microfibrillated cellulose and/or highly refined pulp of the fibrous suspension is in the range of from 4 to 12 weight-% based on total dry solid content.

Preferably, the microfibrillated cellulose and/or highly refined pulp of the fibrous suspension is never-dried microfibrillated cellulose and/or highly refined pulp.

Preferably, the solid content of the fibrous suspension is at least 0.4%, i.e. 1 kg of the suspension contains at least 4 grams of suspended in material in solid form. More preferably, the solid content of the fibrous suspension is at least 0.5%.

In the highly refined pulp and/or the microfibrillated cellulose used according to the present invention, the average width of the particles or fibers therein is at least 5 μm, preferably at least 10 μm.

In the highly refined pulp and/or the microfibrillated cellulose used according to the present invention, the average length of the particles or fibers therein is preferably in the range of from 20% to 60% of the average length of the fibers before being processed into the highly refined pulp or microfibrillated cellulose.

The highly refined pulp and/or the microfibrillated cellulose is preferably wet when being mixed with the pulp furnish. Thus, the highly refined pulp and/or the microfibrillated cellulose is provided in the form of a suspension, preferably an aqueous suspension.

The dewatering resistance of the fibrous suspension according to the present invention, measured as Schopper-Riegler (SR) number, is in the range of 14-20, as determined by standard ISO 5267-1. Preferably, the SR number is in the range of 15-18.

The fibrous suspension according to the present invention preferably has a pH in the range of from 3 to 10, preferably in the range of from 4 to 7.

The drying of the fibrous suspension to obtain the modified pulp having a moisture content of less than 15% is carried out using methods known in the art and may, according to one embodiment be performed by vacuum, hot air, hot calenders, wet pressing or a combination thereof. It has surprisingly been found that the present invention minimizes the degree of hornification of the microfibrillated cellulose and/or highly refined pulp. This is particularly advantageous since the properties of the microfibrillated cellulose and/or highly refined pulp are preserved during drying, so reslushing followed by the final forming still benefits from the improved properties of the microfibrillated cellulose and/or highly refined pulp. Therefore, the modified pulp can readily be transported in the dry state (moisture content less than 15%) and later be resuspended to obtain a resuspended modified pulp wherein the properties of the microfibrillated cellulose and/or highly refined pulp essentially correspond to the properties thereof prior to drying. Preferably, the modified pulp has a moisture content less than 10%, more preferably less than 8%.

The moisture content of the modified pulp can be determined using methods known in the art, such as thermogravimetrically according to ISO 638:2008.

The modified pulp according to the present invention comprises from 10 to 20% lamella-like fines, wherein the lamella-like fines are particles having width less than 10 μm and length over 0.2 mm and wherein the percentage is a percentage of length, wherein the sum length of the lamella-like fines is divided by the sum length of all measured particles longer than 0.2 mm and multiplied by 100. The lamella-like fines defined herein constitute a portion of the total amount of fines. The fines are cellulose-based. Preferably the modified pulp comprises from 14 to 18% lamella-like fines. The amount of lamella-like fines can be determined according to ISO16065 using a Valmet Fiber Image Analyzer (Valmet FS5).

The modified pulp according to the present invention can be used to produce fibrous products. For such use, the modified pulp is re-suspended in water using methods known in the art. The re-suspended modified pulp can be used in production of fibrous products without refining. Optionally, the re-suspended modified pulp can be subjected to refining before being used in the production of fibrous products. If such refining is carried out, the energy input for the refining is preferably less than 150 kWh per ton solids subjected to the refining. The refining is optionally carried out in the presence of inorganic particles.

In one embodiment the production of the fibrous product is done in a paper making machine using a porous wire on which a fibrous web is formed.

According to one embodiment the production speed of said paper making machine may be in the range of 20 to 1200 m/min.

The modified pulp according to the present invention can be used for example in the manufacture of paper, films, board, coating, barrier coating, adhesives, paints, cosmetic, nonwoven products, strings, yarn, composites and other products in which it is desirable to include microfibrillated cellulose and/or highly refined pulp. In the manufacture of paper, the suspension according to the fifth aspect of the invention is typically added to the wet end of a conventional process for papermaking. The proportion or amount of suspension added to the wet end depends on the desirable characteristics of the paper product to be produced.

The fibrous product may also be a three-dimensional shaped object, such as a tray or cup, which may for example be produced using moulding according to methods known in the art. Examples of such moulded products are trays, bowls and other 3D-formed articles. It has been found that moulded articles produced from the modified pulp according to the present invention are more dense and exhibit lower air and oil permeability, higher strength and bending resistance and twice as high stretch compared to corresponding products manufactured from a traditional softwood pulp or from a mixture of softwood and hardwood pulp.

In one embodiment, the fibrous product is paper, preferably a grease proof paper or glassine paper or a high-density paper.

When the fibrous product is a paper, paperboard or film, it may form part of a laminate, wherein the laminate also comprises other layers or films, such as a thermoplastic polymer, such as any one of a polyethylene, a polyethylene terephthalate and a polylactic acid.

The microfibrillated cellulose used according to the present invention preferably has a Schopper Riegler value (SR°) of more than 75 SR°, or more than 80 SR° or more than 90 SR or more than 93 SR°, or more than 95 SR°.

The microfibrillated cellulose is preferably provided in the form of a suspension. The amount of microfibrillated cellulose in the suspension is preferably in the range of from 40 to 100 weight-% based on total dry solid content. The solid content of the suspension of microfibrillated cellulose is preferably in the range of from 0.1 wt-% to 5 wt-%, such as from 1 wt-% to 4 wt-%.

Microfibrillated cellulose (MFC) shall in the context of the patent application be understood to mean a nano scale cellulose particle fiber or fibril with at least one dimension less than 100 nm. MFC comprises partly or totally of fibrillated cellulose or lignocellulose fibers. The liberated fibrils have a diameter less than 100 nm, whereas the actual fibril diameter or particle size distribution and/or aspect ratio (length/width) depends on the source and the manufacturing methods. The smallest fibril is called elementary fibril and has a diameter of approximately 2-4 nm (see e.g. Chinga-Carrasco, G., Cellulose fibres, nanofibrils and microfibrils,: The morphological sequence of MFC components from a plant physiology and fibre technology point of view, Nanoscale research letters 2011, 6:417), while it is common that the aggregated form of the elementary fibrils, also defined as microfibril (Fengel, D., Ultrastructural behavior of cell wall polysaccharides, Tappi J., March 1970, Vol 53, No. 3.), is the main product that is obtained when making MFC e.g. by using an extended refining process or pressure-drop disintegration process. Depending on the source and the manufacturing process, the length of the fibrils can vary from around 1 to more than 10 micrometers. A coarse MFC grade might contain a substantial fraction of fibrillated fibers, i.e. protruding fibrils from the tracheid (cellulose fiber), and with a certain amount of fibrils liberated from the tracheid (cellulose fiber).

There are different acronyms for MFC such as cellulose microfibrils, fibrillated cellulose, nanofibrillated cellulose, fibril aggregates, nanoscale cellulose fibrils, cellulose nanofibers, cellulose nanofibrils, cellulose microfibers, cellulose fibrils, microfibrillar cellulose, microfibril aggregates and cellulose microfibril aggregates. MFC can also be characterized by various physical or physical-chemical properties such as its large surface area or its ability to form a gel-like material at low solids (1-5 wt %) when dispersed in water. The cellulose fiber is preferably fibrillated to such an extent that the final specific surface area of the formed MFC is from about 1 to about 200 m²/g, or more preferably 50-200 m²/g when determined for a freeze-dried material with the BET method.

The MFC used according to the present invention preferably has a particle size of less than 50, preferably less than 40 percentage of length weighted distribution, categorized as very short fibres 0-0.2 mm width ≥10 μm (FS5 fines level) normally excluded from the fibre length calculation. The MFC used preferably has FS5 fibrillation higher than 1.5%, more preferably higher than 1.8% or higher than 2.0%, such as from 4% to 6%. The fines level and fibrillation can be measured using a Valmet FS5 Fiber Image Analyzer.

Various methods exist to make MFC, such as single or multiple pass refining, pre-hydrolysis followed by refining or high shear disintegration or liberation of fibrils. One or several pre-treatment steps are usually required in order to make MFC manufacturing both energy efficient and sustainable. The cellulose fibers of the pulp to be utilized may thus be pre-treated, for example enzymatically or chemically, to hydrolyse or swell the fibers or to reduce the quantity of hemicellulose or lignin. The cellulose fibers may be chemically modified before fibrillation, such that the cellulose molecules contain other (or more) functional groups than found in the native cellulose. Such groups include, among others, carboxymethyl (CMC), aldehyde and/or carboxyl groups (cellulose obtained by N-oxyl mediated oxidation, for example “TEMPO”), quaternary ammonium (cationic cellulose) or phosphoryl groups. After being modified or oxidized in one of the above-described methods, it is easier to disintegrate the fibers into MFC or nanofibrils.

The nanofibrillar cellulose may contain some hemicelluloses, the amount of which is dependent on the plant source. Mechanical disintegration of the pre-treated fibers, e.g. hydrolysed, pre-swelled, or oxidized cellulose raw material is carried out with suitable equipment such as a refiner, grinder, homogenizer, colloider, friction grinder, ultrasound sonicator, fluidizer such as microfluidizer, macrofluidizer or fluidizer-type homogenizer. Depending on the MFC manufacturing method, the product might also contain fines, or nanocrystalline cellulose, or other chemicals present in wood fibers or in papermaking process. The product might also contain various amounts of micron size fiber particles that have not been efficiently fibrillated.

MFC is produced from wood cellulose fibers, both from hardwood or softwood fibers. It can also be made from microbial sources, agricultural fibers such as wheat straw pulp, bamboo, bagasse, or other non-wood fiber sources. It is preferably made from pulp including pulp from virgin fiber, e.g. mechanical, chemical and/or thermomechanical pulps. It can also be made from broke or recycled paper.

Preferably, the MFC has a high aspect ratio, i.e. length/diameter in the range of at least 100:1, preferably at least 500:1 or more preferably at least 1000:1. Preferably, the MFC is never-dried MFC or MFC that has been subjected to drying or MFC that has been concentrated to a dryness of at least 20%.

The fibrous suspension used according to the present invention may also comprise other additives, such as fillers, pigments, retention chemicals, cross-linkers, optical dyes, fluorescent whitening agents, de-foaming chemicals, salts, pH adjustment chemicals, surfactants, biocides, optical chemicals, pigments, nanopigments (spacers or fillers) etc.

### EXAMPLES

### Example 1

A kraft pulp furnish from softwood and a dispersion comprising microfibrillated cellulose (MFC) were provided.

The following mixtures were prepared:

TABLE 1

| Sample | 1 | 2 | 3 |
|---|---|---|---|
| Softwood pulp | 100% | 95% | 90% |
| MFC | | 5% | 10% |
| Schopper- | 13.0 | 15.0 | 16.0 |
| Riegler, ISO | | | |
| 5267-1 | | | |
| pH (mixing tank) | 4.6 | 4.7 | 4.7 |
| Lamella-like | 7.1% | 13.1% | 18.9% |
| fines (mixing | | | |
| tank) | | | |

The suspensions were dewatered on wire under vacuum, pressed and dried with indirect steam to dry matter content >90%.

Dried pulp suspensions were beaten in a Voith-Sulzer refiner. Laboratory sheets for testing were produced according to ISO 5269-1 and properties of the papers were measured.

TABLE 2

| Sample | 1 | | 2 | | 3 | |
|---|---|---|---|---|---|---|
| Grammage, g/m² | 65.3 | | 64.9 | | 65.3 | |
| Initial wet strength | 0.98 | Nm/g | 1.17 | Nm/g | 1.33 | Nm/g |
| at 35% dry content | | | | | | |
| (at 0 kWh/ton | | | | | | |
| refining) | | | | | | |
| Bulk (at 0 kWh/ton) | 1.68 | cm³/g | 1.65 | cm³/g | 1.62 | cm³/g |
| Bulk (at SR 20) | 1.41 | cm³/g | 1.45 | cm³/g | 1.58 | cm³/g |
| Air permeability (at | 73.9 | μm/Pas | 52.2 | μm/Pas | 25.2 | μm/Pas |
| 0 kWh/ton) | | | | | | |
| Stretch, (at 0 | 3.2% | | 3.6% | | 4.0% | |
| kWh/ton) | | | | | | |

Initial wet strength was measured according to SCAN-CM 69:09. After sheet making and wet pressing the tensile strength of test pieces were tested in a tensile testing machine as described in ISO 1924-3. The test pieces were allowed to dry for different periods of time in the clamps before the tensile test was started. The dry matter content of each test piece was measured immediately after the tensile test. The value at the specified dry matter content was obtained by interpolation.

Air permeability was measured according to ISO 5636-5. Five test pieces were cut from conditioned lab sheets and measured in the air resistance apparatus (Gurly tester). The average air permeability was calculated.

Stretch was measured according to ISO 1924-2. Ten test pieces with a width (15+0.1) mm and long enough to be clamped in the clamps were cut from conditioned lab sheets. Stretch or strain at break were measured as the elongation of the specimen during the measurement of the force applied at break in percent of the initial test length.

### Example 2

A softwood pulp without modification (sample 1 of Example 1), a modified softwood pulp (sample 3 of Example 1), and a pulp mix containing 70% hardwood and 30% softwood were evaluated as raw material in moulded products. The third sample is a commonly preferred furnish for 3-D structure moulded products combining high demands on surface properties as smoothness and barrier functionality and product rigidity.

Three kilos (as dry) of each dried sample were disintegrated at 6 wt-% consistency in a disintegrator for 20 minutes at room temperature. When the dried pulp was defibrated the pulp slurry was diluted to 0.5 wt-% and pH and SR measured. A hydrophobizing agent, AKD, was added (4 kg/tonne pulp) and the slurry thereafter stirred for 30 minutes before entering the production unit.

TABLE 3

| | 1 | 2 | 3 |
|---|---|---|---|
| | Sample | | |
| | Softwood pulp | Modified pulp | 70% hw/30% sw |
| Schopper- | 15.3 | 22.2 | 19.6 |
| Riegler, ISO | | | |
| 5267-1 | | | |
| pH (mixing tank) | 5.8 | 5.9 | 5.4 |
| Fibre length | 2.07 | 1.95 | 0.92 |
| Mean fibril area | 0.9 | 3.2 | 1.2 |
| % | | | |
| Crill quota UV/IR | 0.98 | 1.086 | 0.928 |

The produced moulded 3-D shaped products were tested after being cut into appropriate sizes. Only the bottom area of the tray was used.

TABLE 4

| Sample | 1 | 2 | 3 |
|---|---|---|---|
| Grammage, g/m² | 432 | 440 | 445 |
| Bulk, cm³/g | 1.41 | 1.37 | 1.73 |
| Air permeability, | 7.92 | 2.6 | 3.31 |
| μm/Pa s | | | |
| Oil Cobb (internal | 291 | 174 | 189 |
| method olive oil), | | | |
| g/m² | | | |
| Tensile index, Nm/g | 17.4 | 25.3 | 24.0 |
| Tensile energy | 0.14 | 0.44 | 0.17 |
| absorption index, J/g | | | |
| Tear index, Tappi, | 12.8 | 15.7 | 5.6 |
| mNm²/g | | | |
| Stretch, % | 1.16 | 2.30 | 1.04 |
| Bending resistance | 6.1 | 7.0 | 8.2 |
| index, Nm⁶/kg³ | | | |

The oil resistance is measured with an internal method based on an earlier SCAN-method, SCAN-P 37:77, Cobb-Ungers method. The tests are done on a test piece with the area 31.7 cm² and a known weight. 2 cl of olive oil (extra virgin) of consumer type is filled in a cup with the open area 12.56 cm². The sheet is put on top of the cup and followed by a steel plate. The pile of cup, sheet and plate is turned upside down while starting to record the contact time. After 28 seconds the sheet is withdrawn from the pile. Any excess of oil is gently wiped of the sheet for 2 seconds. The sheet is finally weighted. The difference in weight after contact with the oil and before are calculated and divided with the area 12.56 cm². The measurement is repeated twice and the average reported as the oil cobb in g/m².

Tensile index, tensile energy absorption index and stretch were measured on a Zwick instrument according to ISO 1924-3:2005. The average was reported for ten measurements. Tear index was measured according to TAPPI 496 cm-85 on ten pieces and average calculated.

Bending resistance was measured according to ISO 2493-1:2010 on ten pieces and average calculated.

The result in Example 2 shows that if the modified pulp according to the present invention is used in moulded products it will result in a more dense product with lower air and oil permeability, higher strength and bending resistance and twice as high stretch compared to a softwood pulp without modification.

Compared to the preferred furnish for high quality moulded products the modified pulp shows both a lower air and oil permeability, but also a much higher strength and stretch. Bending resistance is not on the same level for the modified pulp but should be possible to increase with a higher bulk.

In view of the above detailed description of the present invention, other modifications and variations will become apparent to those skilled in the art. However, it should be apparent that such other modifications and variations may be effected without departing from the spirit and scope of the invention.

1. A method for the production of a modified pulp, wherein the method comprises the steps of:
providing a wood pulp furnish;
mixing the wood pulp furnish with highly refined pulp, microfibrillated cellulose, or both to obtain a fibrous suspension, wherein the total content of the highly refined pulp and microfibrillated cellulose in the fibrous suspension obtained is in the range of from 2 to 15 weight-%, based on a total dry solid content, wherein the fibrous suspension has a dewatering resistance measured as Schopper-Riegler (SR) number in the range of 14-20, as determined by standard ISO 5267-1; and. drying the fibrous suspension to obtain a modified pulp having a moisture content of less than 15 wt-%.

2. The method according to claim 1, wherein the fibrous suspension has a dewatering resistance measured as Schopper-Riegler (SR) number in the range of 15-18, as determined by standard ISO 5267-1.

3. The method according to claim 1, wherein the modified pulp comprises from 10 to 20% lamella-like fines,
wherein the lamella-like fines are particles having a width less than 10 μm and a length over 0.2 mm, determined according to ISO16065, and
wherein the percentage is a percentage of length, wherein the sum length of the lamella-like fines is divided by the sum length of all measured particles longer than 0.2 mm and multiplied by 100 to calculate said percentage.

4. The method according to claim 3, wherein the modified pulp comprises from 14 to 18% lamella-like fines.

5. The method according to claim 1, wherein the wood pulp in the wood pulp furnish has a hemicellulose content in the range of 10-30% by weight, based on the total dry weight of the pulp.

6. The method according to any one of claims 1-5, wherein the wood pulp in the wood pulp furnish has a lignin content below 15% by weight, based on the total dry weight of the wood pulp.

7. The method according to claim 1, wherein the highly refined pulp has a content of fibers having a length >0.2 mm of at least 12 million fibers per gram based on a dry weight.

8. The method according to claim 7, wherein the highly refined pulp has a crill value of at least 1.7.

9. A The method according to claim 1, wherein the wood pulp furnish is mixed with a highly refined pulp that has a content of fibers having a length >0.2 mm of at least 12 million fibers per gram based on a dry weight.

10. A modified pulp obtained by the method of claim 1.

11. A Modified modified pulp having a moisture content of less than 15% and comprising in a range of from 10 to 20% lamella-like fines, determined according to ISO16065, wherein the lamella-like fines are particles having a width less than 10 μm and a length over 0.2 mm and wherein the percentage is a percentage of length, wherein a sum length of the lamella-like fines is divided by a sum length of all measured particles longer than 0.2 mm and multiplied by 100 to calculate said percentage.

12. A method for preparing a fibrous product comprising the steps of
preparing a fibrous suspension of the modified pulp according to the method of claim 1;
forming an intermediate product comprising the fibrous suspension; and,
dewatering and drying the intermediate product to a moisture content of less than 15 wt-% to obtain the fibrous product.

13. A fibrous product comprising: the modified pulp according to claim 10.

14. The fibrous product according claim 13, wherein the fibrous product is paper, films, board, coating, barrier coating, adhesive, paint, cosmetic, nonwoven product, string, yarn, composite, or a molded fiber article.

15. The fibrous product according to claim 14, wherein the fibrous product is a grease proof paper or glassine paper.

16. A fibrous suspension comprising:
a wood pulp furnish; and
a highly refined pulp, or microfibrillated cellulose, or both,
wherein the total content of the highly refined pulp and microfibrillated cellulose in the fibrous suspension obtained is in a range of from 2 to 15 weight-%, based on a total dry solid content,
wherein the fibrous suspension has a dewatering resistance measured as Schopper-Riegler (SR) number in the range of 14-20, as determined by standard ISO 5267-1,
wherein the fibrous suspension comprises from 10 to 20% lamella-like fines, determined according to ISO16065,
wherein the lamella-like fines are particles having a width less than 10 μm and a length over 0.2 mm, and w
herein the percentage is a percentage of length, wherein a sum length of the lamella-like fines is divided by a sum length of all measured particles longer than 0.2 mm and multiplied by 100 to calculate said percentage.
